(19) United States
(12) Patent Application Publication
(10) Pub. No.: US 2015/0283800 A1
(43) Pub. Date: Oct. 8, 2015

(54) COMBINATION PRINTER

(71) Applicant: KOMORI CORPORATION, Tokyo (JP)

(72) Inventor: Hiroyoshi Kamoda, Tsukuba-shi (JP)

(73) Assignee: KOMORI CORPORATION, Tokyo (JP)

(21) Appl. No.: 14/437,352

(22) PCT Filed: Oct. 8, 2013
(86) PCT No.: PCT/JP2013/077282

§ 371 Date: Apr. 21, 2015

(30) Foreign Application Priority Data
Oct. 22, 2012 (JP) 2012-232940

(51) Int. Cl. B41F 13/00; B65H 43/04; B65H 29/22; B65H 5/06

(52) U.S. Cl. CPC B41F 13/0032; B65H 5/068; B65H 43/04; B65H 29/22

(57) ABSTRACT

A combination printer (100) is provided with: first and second number-printing units (111, 116) provided with impression cylinders (112, 117) which hold and convey paper (W), number cylinders (113, 118) which are disposed facing and in contact with lower parts of the impression cylinders (112, 117), and which perform number printing on paper held on the impression cylinders (112, 117), and ink devices (114, 119) which supply ink to the number cylinders (113, 118); a one-surface coating unit (135) for coating one surface of paper from the second number printing unit (116); an other-surface coating unit (126) for coating another surface of paper from the second number printing unit (116); and a waste paper device (140) provided with a plurality of loading platforms (143a-143c) upon which paper from the one-surface coating unit (135) is loaded. The combination printer (100) is configured such that only conveyance cylinders (120, 122) form a link between the second number printing unit (116) and the other-surface coating unit (126).

### TECHNICAL FIELD

The present invention relates to a combination printing press capable of performing number printing and double-sided coating in one pass.

### BACKGROUND ART

In printing of securities and the like, numbers, seals, barcodes, overprints, and the like are additionally printed on a sheet on which patterns are printed, and further, coating is performed on the sheet to improve durability.

As printers which perform such printing, there are known a printer which performs number printing and relief printing or double-sided offset printing of seals, barcodes, overprints and the like in one pass (see Patent Literature 1) and a printer which performs double-sided coating and double-sided offset printing in one pass (see Patent Literature 2).

### CITATION LIST

### Patent Literature

Patent Literature 1: Japanese Patent Application Publication No. 2000-62134

Patent Literature 2: Japanese Patent Application Publication No. 2000-103035

### SUMMARY OF INVENTION

### Technical Problem

However, in the conventional printer as described above, work of delivering sheets from a number printing machine and work of feeding sheets to a coater is necessary to perform coating after the number printing. Moreover, after the number printing, registration needs to be performed again in the coater. Due to such reasons, a burden on an operator is great in terms of man-hours and maintaining the quality of printing and coating.

In view of this, an object of the present invention is to provide a combination printing press capable of performing number printing and double-sided coating in one pass.

### Solution to Problem

A combination printing press of the present invention for solving the problems described above is characterized that the combination printing press comprises: a number printing part including number printing means, the number printing means having an impression cylinder configured to hold and convey a sheet, a number cylinder being in contact with a lower portion of the impression cylinder and configured to perform number printing on the sheet held by the impression cylinder, and ink supplying means for supplying ink to the number cylinder; a coating part having one-surface coating processing means for coating one surface of the sheet from the number printing part and other-surface coating processing means for coating another surface of the sheet from the number printing part; and a sheet delivery part having a plurality of stacking trays on which the sheet from the coating part is stacked, and the number printing part and the coating part are connected to each other only by a cylinder.

Moreover, the combination printing press of the present invention is characterized in that the aforementioned combination printing press further comprises a relief printing part configured to perform relief printing on the sheet before the sheet is subjected to coating processing in the coating part.

Furthermore, the combination printing press of the present invention is characterized in that the aforementioned combination printing press further comprises checking means for checking printing quality of the sheet after the sheet is subjected to number printing in the number printing part and before the sheet is subjected to coating processing in the coating part.

Moreover, the combination printing press of the present invention is characterized in that the aforementioned combination printing press further comprises first drying means for drying the sheet after the sheet is subjected to number printing in the number printing part and before the sheet is subjected to coating processing in the coating part.

Furthermore, the combination printing press of the present invention is characterized in that the aforementioned combination printing press further comprises second drying means for, after one of the one surface and the other surface of the sheet is subjected to coating processing in the coating part, drying the one of the one surface and the other surface of the sheet before the other one of the one surface and the other surface of the sheet is subjected to coating processing.

Moreover, the combination printing press of the present invention is characterized in that the aforementioned combination printing press further comprises third drying means for drying the sheet after the sheet is subjected to coating processing in the coating part and before the sheet is stacked on any of the stacking trays of the sheet delivery part.

Furthermore, the combination printing press of the present invention is characterized in that, in the aforementioned combination printing press, the number printing part includes a plurality of the number printing means.

### Advantageous Effects of Invention

Since the combination printing press of the present invention can perform number printing and double-sided coating in one pass, it is possible to complete printing and coating by performing sheet conveyance once and improve the quality and productivity of the printing and coating. In addition, a burden on an operator can be reduced.

Moreover, since the number printing part is a part in which the number cylinder is in contact with the lower portion of the impression cylinder, it is possible to easily perform adjustment and maintenance work of the number cylinder and further reduce the burden on the operator. In addition, since the number printing part and the coating part are connected to each other only via the cylinder, it is possible to pass the sheet with high accuracy and further improve the quality of printing and coating with high registration accuracy.

### BRIEF DESCRIPTION OF DRAWINGS

FIG. 1 is a schematic side view showing a configuration of a first embodiment of a combination printing press in the present invention.

FIG. 2 is a schematic side view showing a configuration of a second embodiment of the combination printing press in the present invention.

FIG. 3 is a schematic side view showing a configuration of a coating part in a third embodiment of the combination printing press in the present invention.

### DESCRIPTION OF EMBODIMENTS

Embodiments of a combination printing press of the present invention are described below based on the drawings. However, the present invention is not limited only to the embodiments described below based on the drawings.

### First Embodiment

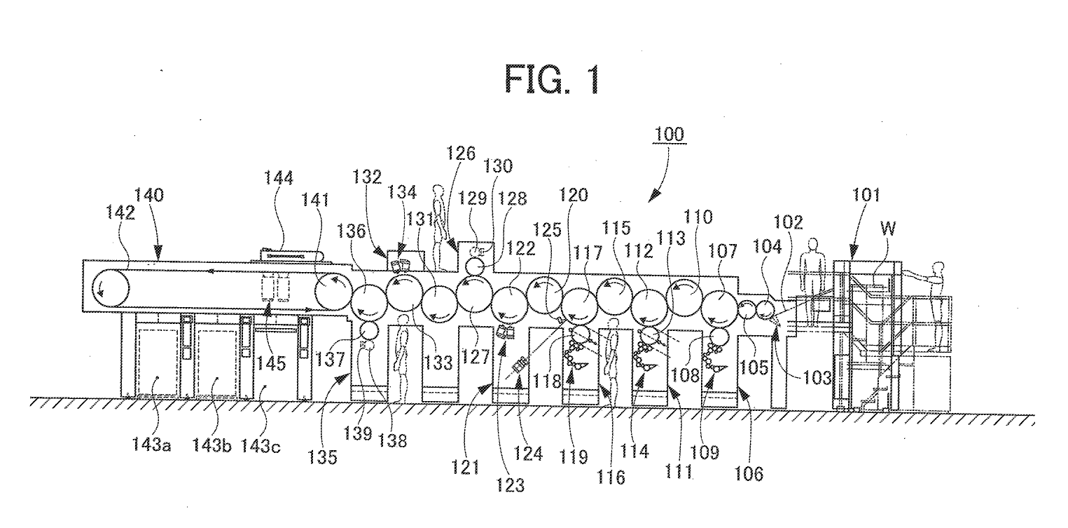

A first embodiment of the combination printing press of the present invention is described based on FIG. 1

As shown in FIG. 1, in the combination printing press 100, a transfer cylinder 104 is disposed on a front end side of a feeder board 102 of a paper feeding device 101 with a swing arm shaft pregripper 103 provided therebetween, the paper feeding device 101 configured to feed paper sheets (sheets) W one by one, the transfer cylinder 104 configured to covey each paper sheet W by gripping and holding a leading edge of the paper sheet W with a gripper (not illustrated). A transfer cylinder 105 configured to convey the paper sheet W by gripping and holding the leading edge of the paper sheet W with a gripper (not illustrated) is in contact with the transfer cylinder 104. The swing arm shaft pregripper 103 can receive the paper sheets W from the feeder board 102 and pass the paper sheets W to the transfer cylinder 105 via the transfer cylinder 104 one by one. In the embodiment, a sheet feeding part is formed of the paper feeding device 101, the feeder board 102, the swing arm shaft pregripper 103, the transfer cylinders 104, 105, and the like which are described above.

An impression cylinder 107 located downstream of a contact position between the transfer cylinder 105 and the transfer cylinder 104 in a rotating direction and configured to convey the paper sheet W by gripping and holding the leading edge of the paper sheet W with a gripper (not illustrated) is in contact with the transfer cylinder 105. A plate cylinder 108 configured to perform relief printing on the paper sheet W held by the impression cylinder 107 is in contact with a lower portion of the impression cylinder 107. An inking device 109 which is ink supplying means for supplying ink to the plate cylinder 108 is provided below the plate cylinder 108. In the embodiment, a relief printing unit 106 which is a relief printing part is formed of the impression cylinder 107, the plate cylinder 108, the inking device 109, and the like which are described above.

A conveyance cylinder 110 located downstream of a contact position (relief printing position) between the impression cylinder 107 and the plate cylinder 108 in the rotating direction and configured to convey the paper sheet W by gripping and holding the leading edge of the paper sheet W with a gripper (not illustrated) is in contact with the impression cylinder 107. An impression cylinder 112 located downstream of a contact position between the conveyance cylinder 110 and the impression cylinder 107 in a paper conveyance direction and configured to convey the paper sheet W by gripping and holding the leading edge of the paper sheet W with a gripper (not illustrated) is in contact with the conveyance cylinder 110. A number cylinder 113 configured to perform number printing on the paper sheet W held by the impression cylinder 112 is in contact with a lower portion of the impression cylinder 112. An inking device 114 which is ink supplying means for supplying ink to the number cylinder 113 is provided below the number cylinder 113. In the embodiment, a first number printing unit 111 which is first number printing means is formed of the impression cylinder 112, the number cylinder 113, the inking device 114, and the like which are described above.

A conveyance cylinder 115 located downstream of a contact position (number printing position) between the impression cylinder 112 and the number cylinder 113 in the rotating direction and configured to convey the paper sheet W by gripping and holding the leading edge of the paper sheet W with a gripper (not illustrated) is in contact with the impression cylinder 112. An impression cylinder 117 located downstream of a contact position between the conveyance cylinder 115 and the impression cylinder 112 in the paper conveyance direction and configured to convey the paper sheet W by gripping and holding the leading edge of the paper sheet W with a gripper (not illustrated) is in contact with the conveyance cylinder 115. A number cylinder 118 configured to perform number printing on the paper sheet W held by the impression cylinder 117 is in contact with a lower portion of the impression cylinder 117. An inking device 119 which is ink supplying means for supplying ink to the number cylinder 118 is provided below the number cylinder 118. In the embodiment, a second number printing unit 116 which is second number printing means is formed of the impression cylinder 117, the number cylinder 118, the inking device 119, and the like which are described above.

A conveyance cylinder 120 located downstream of a contact position (number printing position) between the impression cylinder 117 and the number cylinder 118 in the rotating direction and configured to convey the paper sheet W by gripping and holding the leading edge of the paper sheet W with a gripper (not illustrated) is in contact with the impression cylinder 117. A conveyance cylinder 122 located downstream of a contact position between the conveyance cylinder 120 and the impression cylinder 117 in the paper conveyance direction and configured to convey the paper sheet W by gripping and holding the leading edge of the paper sheet W with a gripper (not illustrated) is in contact with the conveyance cylinder 120. Two drying lamps 123 are provided below the conveyance cylinder 122 to face a peripheral surface of the conveyance cylinder 122. In the embodiment, a first drying unit 121 which is first drying means is formed of the conveyance cylinder 122, the drying lamps 123, and the like which are described above.

Moreover, a checking device 124 which is checking means for checking the printing state of the paper sheet W conveyed between the contact position of the impression cylinder 117 with the number cylinder 118 and the contact position of the impression cylinder 117 with the conveyance cylinder 120 is provided between these contact positions together with a lighting unit 125 to face a peripheral surface of the impression cylinder 117. An optical or electronic image capturing device such as a CCD line camera or a CCD line sensor can be employed as the checking device 124.

An impression cylinder 127 located downstream, in the paper conveyance direction, of a position of the conveyance cylinder 122 which the drying lamps 123 face and configured to convey the paper sheet W by gripping and holding the leading edge of the paper sheet W with a gripper (not illustrated) is in contact with the conveyance cylinder 122. A coating cylinder 128 configured perform coating on another surface (back surface) of the paper sheet W held by the impression cylinder 127 is in contact with an upper portion of the impression cylinder 127. An anilox roller 129 and a chamber coater 130 configured to supply coating liquid such as varnish onto a plate surface of a plastic plate of the coating cylinder 128 is provided above the coating cylinder 128. In the embodiment, an other-surface coating unit 126 which is other-surface coating processing means is formed of the impression cylinder 127, the coating cylinder 128, the anilox roller 129, the chamber coater 130, and the like which are described above.

A conveyance cylinder 131 located downstream of a contact position between the impression cylinder 127 and the coating cylinder 128 in the rotating direction and configured to convey the paper sheet W by gripping and holding the leading edge of the paper sheet W with a gripper (not illustrated) is in contact with the impression cylinder 127. A conveyance cylinder 133 located downstream of a contact position between the conveyance cylinder 131 and the impression cylinder 127 in the paper conveyance direction and configured to convey the paper sheet W by gripping and holding the leading edge of the paper sheet W with a gripper (not illustrated) is in contact with the conveyance cylinder 131. Two drying lamps 134 are provided above the conveyance cylinder 133 to face a peripheral surface of the conveyance cylinder 133. A second drying unit 132 which is second drying means is formed of the conveyance cylinder 133, the drying lamps 134, and the like which are described above.

An impression cylinder 136 located downstream, in the paper conveyance direction, of a position of the conveyance cylinder 133 which the drying lamps 134 face and configured to convey the paper sheet W by gripping and holding the leading edge of the paper sheet W with a gripper (not illustrated) is in contact with the conveyance cylinder 133. A coating cylinder 137 configured perform coating on one surface (front surface) of the paper sheet W held by the impression cylinder 136 is in contact with a lower portion of the impression cylinder 136. An anilox roller 138 and a chamber coater 139 configured to supply varnish onto a plate surface of a plastic plate of the coating cylinder 137 is provided below the coating cylinder 137. A one-surface coating unit 135 which is one-surface coating processing means is formed of the impression cylinder 136, the coating cylinder 137, the anilox roller 138, the chamber coater 139, and the like which are described above.

A delivery cylinder 141 is in contact with the impression cylinder 136 to be located downstream, in the paper conveyance direction, of a position of the impression cylinder 136 which the coating cylinder 137 faces. A not-illustrated sprocket is coaxially provided on the delivery cylinder 141 and an endless conveyance chain 142 provided with multiple gripper bars is wound around the sprocket. Multiple (three in the illustrated example) stacking trays 143a to 143c on which the paper sheets W are stacked are installed below the conveyance chain 142 along a travelling direction of the conveyance chain 142. Here, the stacking trays 143a, 143b are platforms for good items to which the paper sheets W determined to be normal as a result of the checking by the checking device 124 are delivered, and the stacking tray 143c is a platform for defective items to which the paper sheets W determined to be abnormal as a result of the checking by the checking device 124 are delivered. In the embodiment, a paper delivery device 140 which is sheet delivering part is formed of the delivery cylinder 141, the conveyance chain 142, the stacking trays 143a to 143c, and the like which are described above.

A suction guide 144 is installed above an upper travelling chain portion of the conveyance chain 142 while two drying lamps 145 which are third drying means are installed below the upper travelling chain portion to face the suction guide 144.

Note that, in the embodiment, a number printing part is formed of the first number printing unit 111, the second number printing unit 116, and the like, and a coating part is formed of the other-surface coating unit 126, the one-surface coating unit 135, and the like.

In the combination printing press 100 of the embodiment described above, when the paper sheets W are fed one by one from the paper feeding device 101 onto the feeder board 102, the paper sheets W are passed one by one to the gripper of the transfer cylinder 104 by the swing arm shaft pregripper 103 and the leading edge side thereof is gripped. Each paper sheet W is passed from the transfer cylinder 104 to the transfer cylinder 105 and the leading edge side thereof is gripped by the gripper of the transfer cylinder 105. Thereafter, the paper sheet W is passed to the impression cylinder 107 of the relief printing unit 106 and the leading edge thereof is gripped by the gripper of the impression cylinder 107 to be held and conveyed with the one surface (front surface) facing outward.

The ink transferred in advance from the inking device 109 onto a surface of the plate cylinder 108 is transferred onto the one surface of the paper sheet W held and conveyed on a peripheral surface of the impression cylinder 107 by causing the paper sheet W to pass between the impression cylinder 107 and the plate cylinder 108, and the relief printing of a seal and the like is thus performed.

The paper sheet W whose one surface is subjected to the relief printing on the impression cylinder 107 is then passed to the conveyance cylinder 110 and the leading edge side thereof is gripped by the gripper of the conveyance cylinder 110. The paper sheet W is passed from the conveyance cylinder 110 to the impression cylinder 112 of the first number printing unit 111 and the leading edge side thereof is gripped by the gripper of the impression cylinder 112. The paper sheet W is thereby held and conveyed by the impression cylinder 112 with the one surface facing outward.

The ink transferred in advance from the inking device 114 onto a surface of the number cylinder 113 is transferred onto the one surface of the paper sheet W held and conveyed on a peripheral surface of the impression cylinder 112 by causing the paper sheet W to pass between the impression cylinder 112 and the number cylinder 113, and first number printing is thus performed.

The paper sheet W whose one surface is subjected to the first number printing on the impression cylinder 112 is then passed to the conveyance cylinder 115 and the leading edge side thereof is gripped by the gripper of the conveyance cylinder 115. Then, the paper sheet W is passed from the conveyance cylinder 115 to the impression cylinder 117 of the second number printing unit 116 and the leading edge side thereof is gripped by the gripper of the impression cylinder 117. The paper sheet W is thereby held and conveyed by the impression cylinder 117 with the one surface facing outward.

The ink transferred in advance from the inking device 119 onto a surface of the number cylinder 118 is transferred onto the one surface of the paper sheet W held and conveyed on a peripheral surface of the impression cylinder 117 by causing the paper sheet W to pass between the impression cylinder 117 and the number cylinder 118, and second number printing is thus performed.

The paper sheet W whose one surface is subjected to the second number printing on the impression cylinder 117 is then passed to the conveyance cylinder 120 and the leading edge side thereof is gripped by the gripper of the conveyance cylinder 120. The printing state on the one surface is checked by using the checking device 124 and the lighting unit 125 before the paper sheet W is passed to and gripped by the conveyance cylinder 120, i.e. in a period after the number printing of the paper sheet W in the number printing units 111, 116 and before coating processing of the paper sheet W in the coating units 126, 135.

The paper sheet W passed to and gripped by the conveyance cylinder 120 is passed to the conveyance cylinder 122 of the first drying unit 121 and the leading edge side thereof is gripped by the gripper of the conveyance cylinder 122. The paper sheet W is thereby held and conveyed by the conveyance cylinder 122 with the one surface facing outward.

In this conveyance, the one surface of the paper sheet W which is subjected to the aforementioned relief printing and first and second number printing and which is not yet subjected to the coating processing in the coating units 126, 135 is heated and dried by the drying lamps 123.

Next, the paper sheet W is passed to the impression cylinder 127 of the other-surface coating unit 126 and the leading edge side thereof is gripped by the gripper of the impression cylinder 127. The paper sheet W is thereby held and conveyed by the impression cylinder 127 with the other surface (back surface) now facing outward.

The coating liquid such as varnish applied in advance from the anilox roller 129 and the chamber coater 130 onto a surface of the coating cylinder 128 is applied onto the other surface of the paper sheet W held and conveyed on a peripheral surface of the impression cylinder 127 by causing the paper sheet W to pass between the impression cylinder 127 and the coating cylinder 128, and the coating processing is thus performed.

The paper sheet W whose other surface is subjected to the coating processing on the impression cylinder 127 is then passed to the conveyance cylinder 131 and the leading edge side thereof is gripped by the gripper of the conveyance cylinder 131. The paper sheet W is passed from the conveyance cylinder 131 to the conveyance cylinder 133 of the second drying unit 132 and the leading edge side thereof is gripped by the gripper of the conveyance cylinder 133. The paper sheet W is thereby held and conveyed by the conveyance cylinder 133 with the other surface facing outward.

In this conveyance, the other surface of the paper sheet W whose other surface is subjected to the coating processing and whose one surface is not subjected to the coating processing is heated and dried by the drying lamps 134.

Next, the paper sheet W is passed to the impression cylinder 136 of the one-surface coating unit 135 and the leading edge side thereof is gripped by the gripper of the impression cylinder 136. The paper sheet W is thereby held and conveyed by the impression cylinder 136 with the one surface (front surface) now facing outward.

The coating liquid such as varnish applied in advance from the anilox roller 138 and the chamber coater 139 onto a surface of the coating cylinder 137 is applied onto the one surface of the paper sheet W held and conveyed on a peripheral surface of the impression cylinder 136 by causing the paper sheet W to pass between the impression cylinder 136 and the coating cylinder 137, and the coating processing is thus performed.

The paper sheet W whose one surface is subjected to the coating processing on the impression cylinder 136 is then passed to the conveyance chain 142 in the paper delivery device 140 via the delivery cylinder 141a to be gripped by the not-illustrated gripper bars of the conveyance chain 142. The paper sheet W is thereby conveyed along the upper travelling chain portion of the conveyance chain 142 with the other surface now facing outward.

Before the paper sheet W is stacked on the stacking trays 143a to 143c, the one surface of the paper sheet W conveyed by the conveyance chain 142 is heated and dried by the drying lamps 145 with the paper sheet W being guided and spread while being sucked by the suction guide 144.

Then, the paper sheet W is conveyed with the travelling of the conveyance chain 142 and selectively delivered to one of the three stacking trays 143a to 143c. Specifically, when the printing state is determined to be normal as a result of the checking by the checking device 124, the paper sheet W is delivered to and stacked on the stacking tray 143a or the stacking tray 143b as a good item. Meanwhile, when the printing state is determined to be abnormal, the paper sheet W is delivered to and stacked on the stacking tray 143c as a defective item. At this time, the paper sheets W delivered onto the stacking trays 143a to 143c are stacked on the stacking trays 143a to 143c with the one surfaces (front surfaces) subjected to the aforementioned relief printing and first and second number printing facing upward.

As described above, in the combination printing press 100 of the embodiment, the relief printing by the relief printing unit 106, the two types of number printing by the first number printing unit 111 and the second number printing unit 116, and the double-sided coating by the other-surface coating unit 126 and the one-surface coating unit 135 can be performed in one pass.

Accordingly, in the combination printing press 100 of the embodiment, there is no need to perform registration again for the double-sided coating after the relief printing and the first and second number printing are performed, and various types of printing and coating can be completed by performing paper conveyance once. Hence, it is possible to improve the quality and productivity of the printing and coating and also reduce a burden on an operator.

Moreover, since there is no need to perform paper feeding work for the double-sided coating and paper delivery work after the relief printing and the first and second number printing, it is possible to greatly reduce the printing preparation time and also reduce the burden on the operator.

Furthermore, since intermediate stocks between the step of double-sided coating and the step of relief printing and first and second printing are eliminated, the intermediate stocks can be reduced. In addition, since intermediate defects between the aforementioned steps are eliminated by integrated production, the level of defectiveness can be reduced.

Moreover, a set of the plate cylinder 108 and the inking device 109 in the relief printing unit 106, a set of the number cylinder 113 and the inking device 114 in the first number printing unit 111, and a set of the number cylinder 118 and the inking device 119 in the second number printing unit 116 are disposed respectively below the impression cylinders 107, 112, 117, i.e. below a conveyance path of the paper sheet W. Accordingly, the operator can easily perform maintenance and management of parts of the printer while standing on a floor. Specifically, in the relief printing unit 106, the operator can easily perform replacement work and cleaning work of the plate as well as maintenance, management, adjustment, and the like of the inking device 109. Moreover, in the first and second number printing units 111, 116, the operator can easily perform attachment and detachment work and position adjustment of multiple numbering machines provided in the number cylinders 113, 118 as well as maintenance, management, adjustment, and the like of the inking devices 114, 119. Hence, the burden on the operator can be further reduced.

Furthermore, since the number printing units 111, 116 and the coating units 126, 135 are connected to each other only by the transfer cylinders 120, 122, it is possible to perform the passing and receiving of the paper sheet W with high accuracy and further improve the quality of printing and coating with high registration accuracy.

Moreover, the relief printing unit 106 and the first number printing unit 111 are connected to each other only by the conveyance cylinder 110, the first number printing unit 111 and the second number printing unit 116 are connected to each other only by the conveyance cylinder 115, and the other-surface coating unit 126 and the one-surface coating unit 135 are connected to each other only by the conveyance cylinders 131, 133, i.e. all of the units 106, 111, 116, 126, 135 are connected to one another only by the conveyance cylinders 110, 115, 120, 122, 131, 133. Accordingly, it is possible to perform passing and receiving of the paper sheet W among all of the units 106, 111, 116, 126, 135 with high accuracy and more surely improve the quality of all printing and coating with high registration accuracy.

Moreover, since the relief printing, the two types of number printing, and the double-sided coating are performed not in a satellite-type configuration but in a unit pattern design, it is possible to easily increase and decrease the number of units and replace an old unit with a new unit, thereby improving versatility.

### Second Embodiment

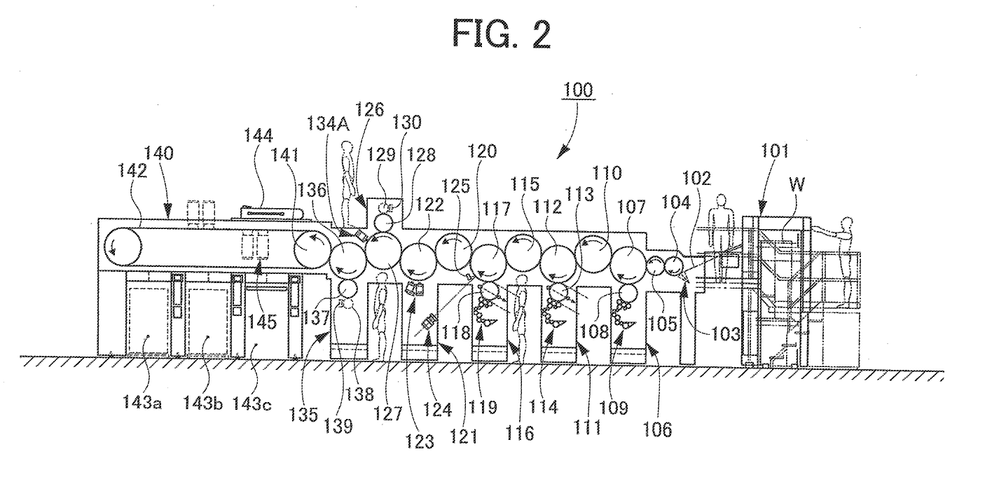

A second embodiment of the combination printing press of the present invention is described based on FIG. 2. The same parts as those in the aforementioned embodiment are denoted by the same reference numeral as those used in the description of the aforementioned embodiment and description overlapping that of the aforementioned embodiment is omitted.

In the combination printing press of the embodiment, the impression cylinder 127 of the other-surface (back-surface) coating unit 126 and the impression cylinder 136 of the one-surface (front-surface) coating unit 135 in the combination printing press of the aforementioned first embodiment are in direct contact with each other, and the conveyance cylinder 131 and the second drying unit 132 formed of the conveyance cylinder 133 and the drying lamps 134 are omitted. Meanwhile, one drying lamp (second drying part) 134A configured to heat and dry the other surface (back surface) of the paper sheet W subjected to the coating processing by the other-surface (back-surface) coating unit 126 is disposed to face an upper peripheral surface (a portion downstream of the contact position between the impression cylinder 127 and the coating cylinder 128 and upstream of the contact position between the impression cylinder 127 and the impression cylinder 136 of the one-surface (front surface) coating unit 135 in the paper conveyance direction) of the impression cylinder 127 in the other-surface (back-surface) coating unit 126.

In the combination printing press of the embodiment, the paper sheet W is directly passed from the impression cylinder 127 of the other-surface (back-surface) coating unit 126 to the impression cylinder 136 of the one-surface (front-surface) coating unit 135, and the relief printing by the relief printing unit 106, the two types of number printing by the first number printing unit 111 and the second number printing unit 116, and the double-sided coating by the other-surface coating unit 126 and the one-surface coating unit 135 can be performed in one pass. Accordingly, the combination printing press of the embodiment has, in addition to the same operations and effects as those in the aforementioned embodiment, such an advantage that the length of the printer can be reduced by the reduction of the number of cylinders which is achieved by the elimination of the second drying unit 132.

### Third Embodiment

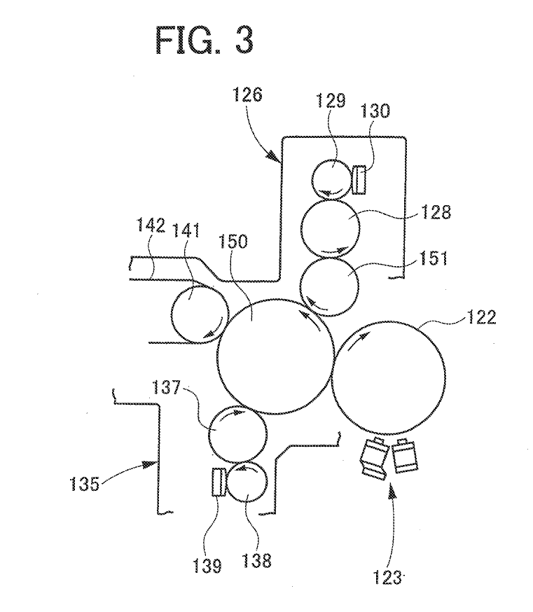

A third embodiment of the combination printing press of the present invention is described based on FIG. 3. The same parts as those in the aforementioned embodiments are denoted by the same reference numeral as those used in the description of the aforementioned embodiments and description overlapping that of the aforementioned embodiments is omitted.

In the combination printing press of the embodiment, a blanket impression cylinder 150 having a gripper is used instead of the impression cylinder 136 (see FIG. 2) on the one-surface (front-surface) coating unit 135 side, between the other-surface (back-surface) coating unit 126 and the one-surface (front-surface) coating unit 135 in the combination printing press of the aforementioned second embodiment, a blanket cylinder 151 is provided instead of the impression cylinder 127 (see FIG. 2) of the other-surface (back-surface) coating unit 126 to come into contact with an upper peripheral surface of the blanket impression cylinder 150, and the transfer cylinder 122 of the first drying unit 121 is in direct contact with a peripheral surface of the blanket impression cylinder 150 at a position upstream of the contact position with the blanket cylinder 151 in the paper conveyance direction. Moreover, a rotating direction of the conveyance chain 142 on the delivery cylinder 141 is opposite to that in the combination printing press of the aforementioned second embodiment. Other configurations are the same as those in the aforementioned second embodiment.

Accordingly, the coating liquid such as varnish applied from the anilox roller 129 and the chamber coater 130 onto the coating cylinder 128 is transferred to the blanket cylinder 151, and the paper sheet W, which is passed from the transfer cylinder 122 to the blanket impression cylinder 150 and whose leading end is gripped and held by the gripping device of the blanket impression cylinder 150, is coated with the coating liquid while passing between the blanket cylinder 151 and the blanket impression cylinder 150. At the same time, the coating liquid such as varnish applied from the anilox roller 138 and the chamber coater 139 onto the coating cylinder 137 is transferred to the blanket impression cylinder 150, and the one surface (front surface) of the aforementioned paper sheet W is then coated with the coating liquid by a printing pressure of the blanket cylinder 151.

In the combination printing press of the embodiment, coating is performed simultaneously on both surfaces of the paper sheet W between the blanket cylinder 151 on the other-surface (back-surface) coating unit 126 side and the blanket impression cylinder 150 on the one-surface (front-surface) coating unit 135 side, and it is possible to perform in one pass the relief printing by the relief printing unit 106, the two types of number printing by the first number printing unit 111 and the second number printing unit 116, and the double-sided coating by the other-surface coating unit 126 and the one-surface coating unit 135. Accordingly, the combination printing press of the embodiment has, in addition to the same operations and effects as those in the combination printing press of the aforementioned second embodiment, such an advantage that the length of the printer can be reduced by the reduction of the number of cylinders which is achieved by the elimination of the impression cylinder 127 (FIG. 2) on the other-surface (back-surface) coating unit 126 side.

### Other Embodiments

In the aforementioned embodiments, the relief printing unit 106 is disposed between the sheet feeding part and the first number printing unit 111. However, as another embodiment, the relief printing unit 106 can be disposed between the second number printing unit 116 and the other-surface coating unit 126 for example. The same operations and effects as those in the aforementioned embodiments can be obtained as long as the relief printing unit 106 is disposed at a position where the relief printing can be performed on the paper sheet W before the coating processing in the coating units 126, 135.

### INDUSTRIAL APPLICABILITY

The combination printing press of the present invention can improve the quality and productivity of printing and coating and also reduce the burden on the operator. Accordingly, the combination printing press is extremely useful in production of notes such as bank notes and securities such as stock certificates and bond certificates.

### REFERENCE SIGNS LIST

100 Combination printing press
101 Paper feeding device
102 Feeder board
103 Swing arm shaft pregripper
104 Transfer cylinder
105 Transfer cylinder
106 Relief printing unit
107 Impression cylinder
108 Plate cylinder
109 Inking device
110 Conveyance cylinder
111 First number printing unit
112 Impression cylinder
113 Number cylinder
114 Inking device
115 Conveyance cylinder
116 Second number printing unit
117 Impression cylinder
118 Number cylinder
119 Inking device
120 Conveyance cylinder
121 First drying unit
122 Conveyance cylinder
123 Drying lamp
124 Checking device
125 Lighting unit
126 Other-surface coating unit
127 Impression cylinder
128 Coating cylinder
129 Anilox roller
130 Chamber coater
131 Conveyance cylinder
132 Second drying unit
133 Conveyance cylinder
134 Drying lamp
134A Drying lamp
135 One-surface coating unit
136 Impression cylinder
137 Coating cylinder
138 Anilox roller
139 Chamber coater
140 Paper delivery device
141 Delivery cylinder
142 Conveyance chain
143a to 143c Stacking tray
144 Suction guide
145 Drying lamp
150 Blanket impression cylinder
151 Blanket cylinder
W Paper sheet (sheet)

1-7. (canceled)

8. A combination printing press comprising:
a number printing part including number printing means, the number printing means having an impression cylinder configured to hold and convey a sheet, a number cylinder being in contact with a lower portion of the impression cylinder and configured to perform number printing on the sheet held by the impression cylinder, and ink supplying means for supplying ink to the number cylinder;
a coating part having one-surface coating processing means for coating one surface of the sheet from the number printing part and other-surface coating processing means for coating another surface of the sheet from the number printing part; and
a sheet delivery part having a plurality of stacking trays on which the sheet from the coating part is stacked, wherein
the number printing part and the coating part are connected to each other only by a cylinder.

9. The combination printing press according to claim 8, further comprising a relief printing part configured to perform relief printing on the sheet before the sheet is subjected to coating processing in the coating part.

10. The combination printing press according to claim 8, further comprising checking means for checking printing quality of the sheet after the sheet is subjected to number printing in the number printing part and before the sheet is subjected to coating processing in the coating part.

11. The combination printing press according to claim 8, further comprising first drying means for drying the sheet after the sheet is subjected to number printing in the number printing part and before the sheet is subjected to coating processing in the coating part.

12. The combination printing press according to claim 8, further comprising second drying means for, after one of the one surface and the other surface of the sheet is subjected to coating processing in the coating part, drying the one of the one surface and the other surface of the sheet before the other one of the one surface and the other surface of the sheet is subjected to coating processing.

13. The combination printing press according to claim 8, further comprising third drying means for drying the sheet after the sheet is subjected to coating processing in the coating part and before the sheet is stacked on any of the stacking trays of the sheet delivery part.

14. The combination printing press according to claim 8, wherein the number printing part includes a plurality of the number printing means.
